(19) United States
(12) Patent Application Publication
(10) Pub. No.: US 2004/0143917 A1
(43) Pub. Date: Jul. 29, 2004

(54) Electric toothbrush

(76) Inventor: Peter Ek, Jarfalla (SE)

Correspondence Address: JACOBSON HOLMAN PLLC, 400 SEVENTH STREET N.W., SUITE 600, WASHINGTON, DC, 20004, US

(21) Appl. No.: 10/475,991

(22) PCT Filed: Apr. 27, 2001
(86) PCT No.: PCT/SE01/00924

(51) Int. Cl. A61C 17/34

(52) U.S. Cl. 15/22.1; 15/28

(57) ABSTRACT

An electric toothbrush has an electric motor (11) and a mechanical coupling arrangement to convert rotary motion of the motor into rotational oscillations of a brush head 21. The mechanical coupling includes a skewed peripheral flange (16) on a shaft (12) that is rotated by the motor. A follower (17) is constrained to move backwards and forwards in plane parallel to a longitudinal axis (A) of the toothbrush. The follower is driven backwards and forwards by the flange (16) in use. The follower is rigidly connected to a brush drive shaft (20) that is pivotable connected to the brush head (13) at one side of its rotational axis.

The invention relates to electric toothbrushes.

Electric toothbrushes are known and widely used having a set of bristles mounted to a brush head that is driven by an electric motor inside a toothbrush handle. The motor may be powered by a battery, also inside the handle, or from a power supply socket adjacent a point-of-use. The brush heads are rotated and/or vibrated by the motor to enhance the operation of the toothbrushes for cleaning teeth. For vibrating a brush head, it is already known to provide various mechanical couplings, including gears, to convert rotational motion of the motor into oscillating motion at the brush head. Such mechanical couplings tend to be complex, possibly unreliable, or expensive.

It is an object of the invention to overcome or to at least reduce these problems.

According to one aspect of the invention there is provided an electric toothbrush having an elongate handle, an electric motor inside the handle, a shaft rotatable about a longitudinal axis of the toothbrush coupled to a rotor of the motor, a brush head rotatably mounted at a remote end of a shank of the toothbrush about an axis transverse to the longitudinal axis carrying bristles extending from the brush head general transversely to the longitudinal axis, in which the drive shaft is provided with a skewed peripheral track, a follower constrained to slide in a plane parallel to and at one side of the longitudinal axis opposite the track, and a brush head drive shaft rigidly connected to the follower and extending generally along the longitudinal axis inside the shank and pivotably connected at its remote end to the brush head at one side of the transverse axis, such that when the shaft is rotated the follower is moved by mechanical engagement with the track forwards and backwards parallel to the longitudinal axis to cause the brush head to rotationally oscillate.

The follower may be resiliently biassed along the horizontal axis towards the brush head.

The follower may be rigidly connected to a bush, that is rotatably mounted on a forward end of the shaft, which is rigidly connected to the brush head drive shaft.

The brush head drive shaft may extend along the longitudinal axis and be cranked an its remote end away from the longitudinal axis.

The track may comprise a flange mounted on the drive shaft, and may be integrally formed with the drive shaft.

The toothbrush may have two or more brush heads mechanically linked so that the brush heads all oscillate when the brush head drive shaft is moved backwards and forwards.

According to another aspect of the invention there is provided a multi-headed toothbrush in which one head is driven to rotationally oscillate by a drive shaft and is mechanically linked to the other head or heads, to cause rotational oscillation thereof.

Electric toothbrushes according to the invention will now be described by way of example with reference to the accompanying drawings in which:

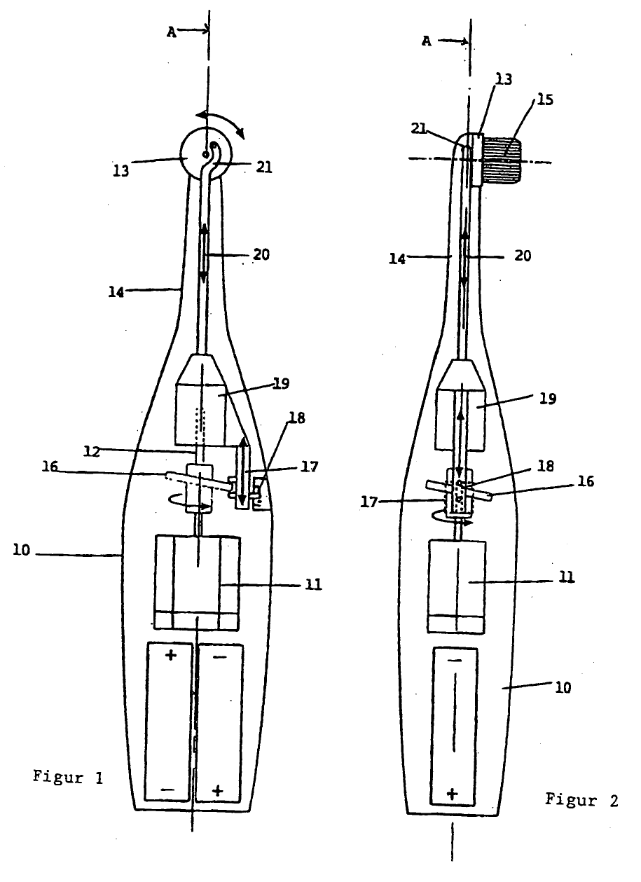

FIG. 1 is a top plan schematic diagram of the toothbrush;

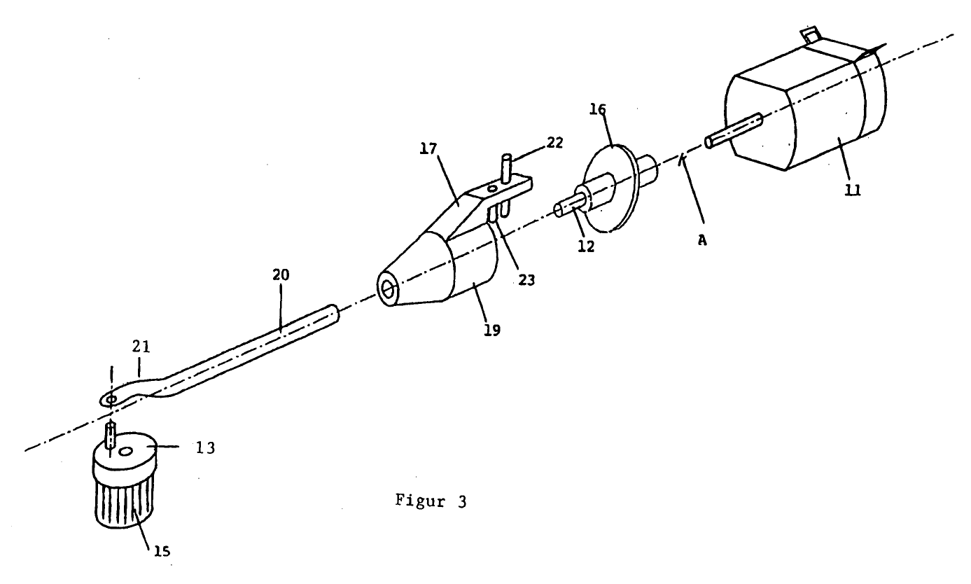

FIG. 2 is an elevation schematic diagram of the toothbrush;

FIG. 3 is an exploded isometric view of mechanical components of the toothbrush.

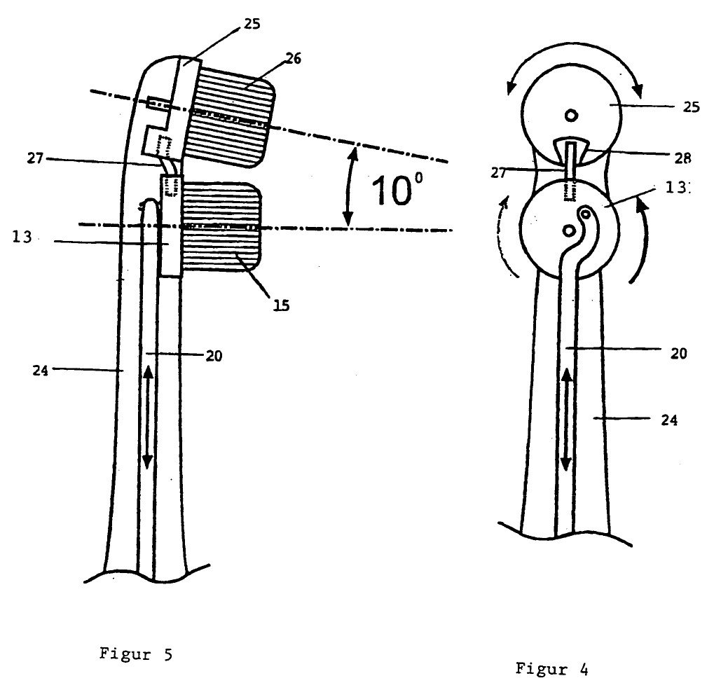

FIG. 4 is top plan schematic diagram of part of another toothbrush; and

FIG. 5 is an elevation schematic diagram of FIG. 4.

Referring to the drawings, in FIGS. 1 and 2 the toothbrush has a elongate handle 10, an electric motor 11 inside the handle and a shaft 12, rotatable about a longitudinal axis A, connected to the motor. A brush head 13 is rotatably mounted to a remote end of a shank 14 of the toothbrush about an axis transverse to the longitudinal axis A. Bristles 15 are mounted to the brush head 13.

The shaft 12 is provided with a skewed track in the form of a peripheral flange 16. A follower 17, that mechanically couples to the flange 16, is constrained to slide in a plane parallel to the longitudinal axis by a slot 18 and mounted at one side of the shaft 12 opposite the flange 16. The follower 17 is integrally formed with a bush 19 that is rotatably and slidably mounted on an end of the shaft 12. The bush 19 is rigidly connected to a brush head drive shaft 20 that extends along inside the shank 14 to a cranked end 21. The cranked end 21 is pivotably connected to the brush head 21 at a location at one side of its rotational axis.

When the motor is turned ON to rotate the shaft 12, and because the flange 16 is skewed, the follower 17 is moved forwards and backwards parallel to the longitudinal axis and urges the brush drive shaft 20 forwards and backward to cause the brush head 21 to rotationally oscillate.

The mechanical components are better seen in FIG. 3. It will be noted that a pin 22 is provided to ride against one side of the flange 16 and also fit into the slot 18 (FIGS. 1 and 2) to constrain the movement of the follower 17 along a path parallel to the longitudinal axis, as explained above. A pin 23 is provided to ride against an opposite side of the flange 16. The pins 22 and 23 together act to cause the follower 17 to move backwards and forwards when the shaft 12 is rotated.

It will be appreciated that one of the pins 22 or 23 may be removed, although the remaining pin must also fit into the slot 18, and the follower 17 resiliently biassed to maintain the remaining pin at all times in sliding contact with an appropriate side of the flange 16. It is also possible to constrain the follower 17 to move (only) backwards and forwards in other ways. For example, a side of the follower body may be arranged to slide in a groove integrally formed on an inside surface of the handle (10).

In the described example, the peripheral flange 16 provides a so-called ‘track’ for mechanical coupling (by pins) to the follower 17. The flange made be integrally formed or machined or ‘bent’ from a plannar shaped washer, so as to provide a skewed peripheral track as required.

It is also possible for the skewed track to be in the form of a peripheral groove provided in a boss on the shaft 12 or formed in an enlarged part of the shaft. In that case, a finger, pin or similar, is provided protruding from the follower 17 that enters into the groove. The follower 17 is then urged by the finger to move backwards and forwards in use in the same manner as before.

Most or all of the separate mechanical components in FIG. 3 may integrally formed by plastics moulding techniques, although the brush drive shaft 20 is preferably metallic. The components are therefore of low cost and are easy to assemble. Thus, the mechanical couplings are relatively simple, the operation of the toothbrush is reliable, and the couplings are efficient, requiring minimum power for their operation. The coupling is also quiet in operation.

In FIGS. 4 and 5, the toothbrush has an extended shank 24 that rotatable supports another brush head 25 supporting bristles 26. A drive link 27, that is rigidly fixed, or integrally moulded, to the brush head 21, is loosely entered into a shaped cavity 28 that allows that link to pivot with respect to the brush head 25. When the brush head 25 is oscillated by the brush drive shaft 20, the link 27 causes the brush head 25 to rotational oscillate. Thus, a double-head toothbrush is provided using a single brush drive shaft.

The toothbrush could be provided with three or more brush heads end-to-end, side-by-side or in array, that are mechanically ‘linked’ together and oscillated by a single brush drive shaft.

It will be noted that the axis of rotation of the brush head 25 is inclined by a few degrees, 10° in the described embodiment. This enables or provides for the bristles 15 and 26 to be configured together in a more convenient or suitable manner for cleaning teeth. Even so, the link 27 serves equally well to transfer oscillations of the brush head 21 to the brush head 25.

It will be appreciated that two, or more, rotationally mounted heads may be provided, as described and mechanically linked together, in which the head 21 is oscillated using a different form of drive arrangement to the drive arrangement described in this specification.

4. An electric toothbrush according to claim 3, characterized in that the brush head drive shaft (20) extends along the longitudinal axis (A) and is cranked on its remote and away from the longitudinal axis (A).

5. An electric toothbrush according to claim 1, characterized in that the track comprises a flange (16) mounted on the drive shaft (12).

6. An electric toothbrush according to claim 5, characterized in that the flange (16) is integrally formed with the drive shaft.

7. An electric toothbrush according to claim 1, characterized in that a second brush head (25) is rotatably mounted to the shank (14) beyond the said brush head (13) and that a pivoted drive link (27) connects the two heads together, which link (27) oscillates the second brush head (25) when the said brush head (13) oscillates.

8. An electric toothbrush according to claim 1, characterized in that the second brush head (25) is rotatable about an axis that is inclined by a few degrees to the transverse axis of said brush head (13).
